(19) United States
(12) Patent Application Publication
(10) Pub. No.: US 2021/0101483 A1
(43) Pub. Date: Apr. 8, 2021

(54) VEHICLE SAFETY APPARATUS AND METHOD

(71) Applicant: Pathfins C. Okezie, Piscataway, NJ (US)

(72) Inventor: Pathfins C. Okezie, Piscataway, NJ (US)

(21) Appl. No.: 16/592,892

(22) Filed: Oct. 4, 2019

(51) Int. Cl. B60K 28/10; B60K 31/18; B60K 28/02; B60K 31/00; G08G 1/0962; F02M 37/00; F02D 41/04

(52) U.S. Cl. CPC B60K 28/10; B60K 31/185; B60K 28/02; B60K 31/0058; B62J 99/00; F02M 37/0023; F02D 41/042; B60K 2031/0091; G08G 1/09623

(57) ABSTRACT

An apparatus including a computer processor; a computer memory, which communicates with the computer processor; and a sensor for detecting traffic signs, which communicates with the computer processor; wherein the computer memory includes data regarding a plurality of safety regulations for vehicles; and wherein the computer processor receives signals from the sensor, and determines whether a vehicle is violating one or more the safety regulations for vehicles based on the signals from the sensor and the data for the plurality of safety regulations stored in the computer memory, and provides a warning signal when a safety regulation is violated. The apparatus may further include a speedometer which communicates with the computer processor; wherein the computer processor is programmed by computer software stored in computer memory to receive speeds from the speedometer to determine if one or more of the safety regulations for vehicles have been violated.

### FIELD OF THE INVENTION

This invention relates to devices concerning vehicle safety.

### BACKGROUND OF THE INVENTION

There are an outrageous and disturbing number of traffic related fatalities annually on our roads and highways. Statistics show that on the average a total number of 40,000 (forty thousand) Americans are killed in motor vehicle related fatalities each year. In addition to the forty thousand motor vehicle related fatalities yearly there are over one million people injured that have to receive medical treatment and rehabilitation/physical therapies. Many of these individuals are maimed, disfigured, or paralyzed and many may be on disability for the rest of their lives. Motor vehicle accidents and its consequences greatly affect our nation's gross nation product (GNP). Some of the causes of these motor vehicle accidents are excessive speeding and failure of vehicle operators to obey traffic rules and regulations.

When survivors of motor vehicle accidents are receiving medical treatment, rehabilitation or therapy, they are not contributing to the nation gross nation product. The forty thousand annual fatalities are just in the United States of America despite various motor vehicle technologies which are designed to reduce automobile accidences. Globally, about one million (1,000,000) people are killed in motor vehicle related accidents annually. Another five million (5,000,000) will receive medical treatment, rehabilitation and physical therapy. The numbers are even worse for developing or less developed countries where little or no traffic fatalities, injuries, rehab or physical therapy records are kept.

### SUMMARY OF THE INVENTION

At least one object of one or more embodiments of the present invention is to reduce or eliminate, if possible, the number of traffic related fatalities and accidents generally, occurring annually on our roads and highways.

In at least one embodiment of the present application, an apparatus is provided comprising: a computer processor; a computer memory, which communicates with the computer processor; and a sensor for detecting traffic signs, which communicates with the computer processor; wherein the computer memory includes data regarding a plurality of safety regulations for vehicles; and wherein the computer processor receives signals from the sensor, and determines whether a vehicle is violating one or more the safety regulations for vehicles based on the signals from the sensor and the data for the plurality of safety regulations stored in the computer memory, and provides a warning signal when a safety regulation is violated.

The apparatus may further include a speedometer which communicates with the computer processor; wherein the computer processor is programmed by computer software stored in computer memory to receive speeds from the speedometer to determine if one or more of the safety regulations for vehicles have been violated.

The apparatus may further include a flapper which is controlled by the computer processor to prevent gas from a gas tank from flowing into an engine of a vehicle when the computer processor detects that one or more of the safety regulations for vehicles have been violated.

The apparatus may further include a yellow indicator light which communicates with the computer processor and which is turned on when a speed of a vehicle as determined by the speedometer is above a first threshold but below a second threshold.

The apparatus may further include a red indicator light which communicates with the computer processor and which is turned on when a speed of a vehicle as determined by the speedometer is above the second threshold.

The apparatus may further include a camera which is configured to take images of a driver of a vehicle and which communicates with the computer processor; and wherein the computer processor is programmed by computer software stored in the computer memory to provide a warning signal when the images of the driver indicate that the driver is not following one or more of the safety regulations.

In at least one embodiment a method is provided comprising fixing an apparatus to a motor vehicle; wherein the apparatus includes components previously referred to.

### BRIEF DESCRIPTION OF THE DRAWINGS

FIG. 1 shows a simplified diagram of a motor vehicle or car, having a scanner, reader or sensor facing outwards and emitting and receiving sensing signals and/or taking video images of objects such as signs, and FIG. 1 also shows a stop sign outside of the motor vehicle;

FIG. 2 shows a simplified block diagram of a scanner/reader or sensor attached to a dashboard which may be within the motor vehicle of FIG. 1, with various other components located on or in the motor vehicle dashboard, and with the stop sign of FIG. 1 shown;

FIG. 3 shows a simplified block diagram of components of a police vehicle;

FIG. 4 shows a simplified diagram of a motorcycle, having a scanner, reader, or sensor facing outwards and emitting and receiving sensing signals and/or taking video images of objects such as signs

### DETAILED DESCRIPTION OF THE DRAWINGS

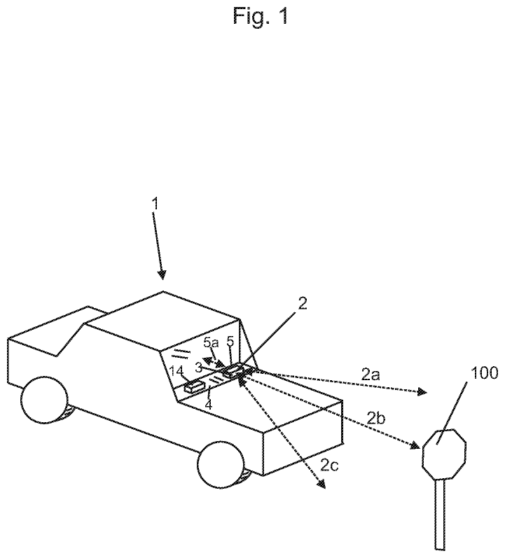

FIG. 1 shows a simplified diagram of a motor vehicle or car 1, having a scanner, reader or sensor 2, attached to a dashboard 4, facing outwards, and emitting and receiving sensing signals and/or taking video images of objects such as signs, and FIG. 1 also shows a stop sign 100 outside of the motor vehicle 1.

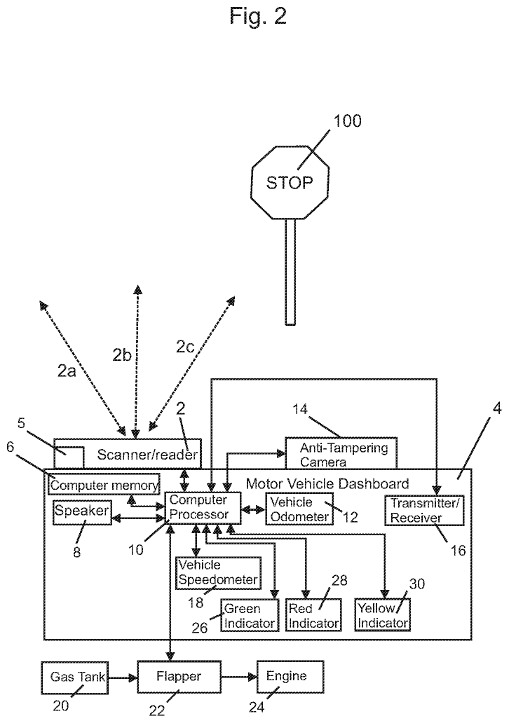

FIG. 2 shows a simplified block diagram of a scanner/reader or sensor 2 attached to a dashboard 4 which may be within the motor vehicle 1 of FIG. 1, with various other components located on or in the motor vehicle dashboard 4, and with the stop sign 100 of FIG. 1 shown. A computer memory 6, a speaker 8, and a vehicle odometer 12 may be electrically connected to and/or may communicate with computer processor 10 in a wire or wireless, and/or remote manner, and the components 6, 8, 10, and 12 may be physically attached to or integrated with the dashboard 4 of the vehicle 1.

The scanner/reader, sensor, and/or camera 2 may be located on the left side of the dashboard, in at least one embodiment. The scanner/reader, sensor, and/or camera may be glued to the left of the vehicle's dashboard 4 so as to make it extremely difficult to be tampered with. The device 2 has a front face 3 shown in FIG. 1, which faces outward from the motor vehicle 1, and through which sensor signals, such as sound waves, light waves, and/or camera images can be taken.

In at least one embodiment, the function of the device 2 is to read/scan any of the traffic safety signs on the road, such as stop signs, yield signs, speeding signs, and such as, for example, the sign 100 shown in FIG. 1 and FIG. 2. The device 2 may read or otherwise sense that the sign 100, for example, is a stop sign, and may provide signals to the computer processor 10 that indicate that the sign 100 is a stop sign. The computer processor 10 may be programmed in accordance with computer software stored in computer memory 6 to cause the speaker 8 to emit a sound indicating that a stop sign has been encountered. For example, there may be a computer or electronic voice, imitating a human voice, which orally “stop sign” and that message may be projected out from the speaker 8. The recording of the message “stop sign” and/or digital data which causes the oral message or sound “stop sign” to be emitted from speaker 8 may be stored in the computer memory 6.

The scanner/reader device 2, the computer processor 10, and the computer memory 6 may be configured so that a traffic sign is detected about preferably 0.4 of a block away from the vehicle 1, and the sound message would be played on the speaker 8 essentially simultaneously with the device 2 sensing the particular traffic sign. The sound message from the speaker 8 may be in the English language or the Spanish language, for example, or in some other language.

The computer processor 10 and the computer memory 6 may be programmed to provide additional sound messages along with an indication of the type of traffic sign or signal. For example, if the motor vehicle 1 and the device 2 approaches a green traffic light a prerecorded or computer voice retrieved from storage in computer memory 6 may be programmed to state: “the street traffic light is green and you can go because you have the right of way”.

Similarly, when a street traffic light is sensed to be red by the device 2, the computer processor 10 and the computer memory 6 may be programmed to cause the speaker 8 to state “please stop before the traffic red light because the traffic light is red and you do not have the right to proceed”. If the street traffic light is yellow as sensed by the device 2, the computer processor 10 and the computer memory 6 may be programmed to state “please be prepared to stop at any moment”.

The device 2 may be waterproof, particularly if the motor vehicle 1 is replaced by or is a motorcycle.

FIG. 1 and FIG. 2 also show an anti-tampering camera 14. The camera 14 may be a micro camera which is used to watch the scanner/reader, sensor, or camera 2 to make sure the device 2 is not tampered with Video and/or signals from the anti-tampering camera 14 may be provided to the computer processor 10, and the computer processor may provide an audio alarm message via speaker 8 to indicate if the device 2 has been tampered with. The audio alarm message indicating tampering may be a different pitch from other audio messages, such as messages providing information about traffic signs and traffic signals. In addition, when the computer processor 10 receives signals and/or video indicating tampering with device 2, the computer processor 10 as programmed by computer software stored in computer memory 6 may transmit a tampering signal to all police patrol vehicles via transmitter/receiver 16.

A tampering signal may be sent out by transmitter/receiver 16 in response to control of computer processor 10 to alert all nearby police patrol officer to the scene of the vehicle via GPS (global positioning satellite). The tampering signal may include location information of the vehicle 1 which has been tampered with and an indication that the scanner/reader or device 2 has been tampered with.

The device 2 may be configured to sense if a pedestrian or cyclist is crossing the street and the computer processor 10 may provide a signal to the speaker 8 to indicate that a pedestrian or cyclist is crossing the street. Alternatively, the device 2 may include an additional micro camera for sensing of pedestrians or individuals riding bikes.

Generally, the computer processor 10 may be programmed by computer software stored in the computer memory 6 to provide an alarm, such as an audio message provided through the speaker 8, whenever the vehicle 1 (and the operator of the vehicle 1) violate any safety rules and regulations which may be stored in computer memory 2. The computer processor 10 may also be connected and/or be in communications with a vehicle speedometer 18. The computer processor 10 may be provided signals by the vehicle speedometer 18 indicating the speed that the vehicle 1 is going. If the vehicle 1 is exceeding the speed limit, the computer processor 10 may sense this via vehicle speedometer 18, and provide an audio message via speaker 8 indicating that the vehicle is exceeding the speed limit. In at least one embodiment, audio messages which indicate that violations of traffic signs or regulations have occurred may be emitted via the speaker 8 until a police patrol officer/s arrives at a location where the vehicle 1 is and deactivates the audio message with the police officer's masters driver's license such as by sending a signal to a receiver of the transmitter/receiver 16, which is relayed or sensed by the computer processor 10 which in response stop an audio message or alarm from being emitted from speaker 8.

The computer processor 10 may be electrically connected to and/or may be in communications with a flapper or device 22 which is along a gas line between a gas tank 20 and an engine 24 of the vehicle 1. The computer processor 10 may also be electrically connected to and/or may be in communications with a green indicator or green light emitting diode 26, a red indicator or red light emitting diode 28, and a yellow indicator or yellow light emitting diode 30. The green indicator or LED (light emitting diode) is typically activated by the computer processor 10 when the vehicle 1 is in park or idle as well as when the vehicle 1 is in motion and the vehicle operator drives the vehicle 1 within the posted speed limit in the neighborhood/zip code area. In at least one embodiment, the computer processor 10 determines the vehicle's speed through the speedometer 18, and determines the posted speed limit through scanner reader or device 2 or from data regarding the geographic area downloaded from the internet received through a receiver of transmitter/receiver 16 and/or from data stored in the computer memory 6. As an example, if the posted speed limit in the area or neighborhood is thirty-five miles per hour and if the vehicle operator drives at about thirty-five miles per hour the green indicator 26 is activated by the computer processor 10 stay to remain green as long as the speed of the vehicle 1 is within a range of the speed limit, such as not more than five miles per hour below, and not more than ten miles per hour above.

However, as soon as the vehicle 1 speed drops more than five miles per hour below the applicable speed limit, in at least one embodiment, the yellow indicator 30 is activated or lit up and the green indicator 26 is deactivated and/or turned off. In addition, the computer processor 10 may cause an audio message to be emitted from the speaker 8 such as a statement “your speed is too low for the posted speed limit in this area.”

Similarly, if the vehicle 1 speed is more than ten miles per hour above the posted speed limit of the computer processor 10 lights up and/or activates the red indicator or LED 28 while the indicators 26 and 30 are not active and are not lit up. In addition, the computer processor 10 will cause an audio message, in at least one embodiment, to be emitted from the speaker 8 to pull over to the side of the road. If after one or more audio messages to “pull over to the side of the road”, the operator does not pull the vehicle 1 over to the side of the road, the flapper or other device 22 will stop gas from flowing from the gas tank 20 to the engine 24, and thereby cause the vehicle 1 to stop moving and the computer processor 10 will cause a signal or message, which includes the GPS location of the vehicle 1 and the nature of the traffic violation of vehicle 1, to be sent via a transmitter of the transmitter/receiver 16 to all law enforcement. Any signals to law enforcement may be appropriately encrypted or encoded so that others may not be able to understand or decipher the signals. The flapper 22 may be located inside of the vehicle 1.

In at least one embodiment, the yellow indicator 30 may be activated by the computer processor 10 to light up as soon as the vehicle 1 goes more than seven miles per hour above the posted speed limit in any neighborhood/zipcode area, and/or a pre-recorded message will be emitted from speaker 8 by the computer processor 10, such as “Please Watch Your Speed” or the flapper 22 will be activated to stop gas from flowing to the engine 24. The computer processor 10 may provide an audio warning via speaker 8, without alerting the police through a transmitter of the transmitter/receiver 16, until the speed limit is exceeded by a higher threshold such as ten miles per hour above the posted speed limit.

The lines 2a, 2b, and 2c, shown in FIGS. 1 and 2, are simplistic representations of signals, radiation, or emissions from the device 2 and back towards the device 2 after reflection from signs, such as sign 100, or after signs or traffic signals are read or video is captured. In addition, original signals may be omitted from signs, such as sign 100, and may be received by device 2.

In at least one embodiment, the flapper or valve 22 opens or closes the vehicle's gas line/supply from the gas tank 20 to the vehicle's engine 24 dependent on the operator driving habits of the vehicle 1. Generally, if the vehicle 1 is driven in a manner which is in compliance with posted speed limits and all other traffic safety rules and regulations on our roads and highways in every zip code and neighborhood, wherein the rules, regulations, and speed limits may be stored in computer memory 6, and/or received via a receiver of the transmitter/receiver 16, the vehicle gas line to the vehicle's engine will not be closed/interrupted electronically. For instance, if the posted speed limit in a neighborhood is twenty-five miles per hour (MPH), the driver may be able to go up to thirty miles an hour, five over the speed limit without the flapper or valve 22 closing. However, if he/she drives above a threshold, such as above five miles per hour above a speed limit, the computer processor 10 will cause a prerecorded audio warning to be emitted via speaker 8 that says something like “please watch your speed” and please always obey the posted limit”.

In at least one embodiment, at any time the vehicle operator drives above ten miles per hour above the speed limit in a twenty-five mile MPH zone/district that will automatically lead to the activation flapper or valve 22 to block the flow of gasoline from the gas tank 20 to the vehicle's engine 24. The vehicle operator, in at least one embodiment, may be warned via audio message by computer processor 10 through speaker 8, that if he/she drives above ten miles MPH above the posted speed limit the flapper or valve 22 may be activated.

To avoid any consequences and inconveniences the vehicle operator, in at least one embodiment, may be advised ahead of time to strictly obey the posted speed limit or any traffic safety signs by computer processor 10 by audio message through speaker 8.

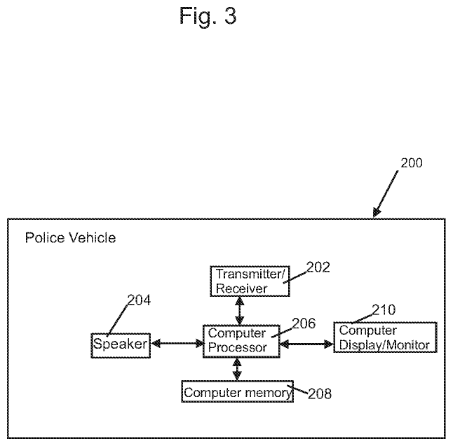

When the flapper or valve 22 is closed to close off gas flow from the gas tank 20 to the engine 24, a vehicle opera smart/digital driver's license may be simultaneously deactivated. In addition, any nearby police patrol officers may be alerted inside his vehicle via a monitor or display 210 in the police officer's vehicle 200, by a computer processor 206 after receiving a signal via a receiver of transmitter/receiver 202 of police vehicle 200 shown in FIG. 3. The police vehicle 300 may include a speaker 204, the transmitter/receiver 202, the computer processor 206, a computer memory 208, and the computer/display monitor 210.

The exact location of a suspect may be identified to the officer via GPS (global positioning satellite) technology and may be provided from motor vehicle 1, from a transmitter of transmitter/receiver 16 via a signal or signals transmitted through the air to transmitter/receiver 202 of the police vehicle 200.

In at least one embodiment of the present invention, when the flapper 22 is activated to cause gas from gas tank 20 to no longer be applied to the engine 24, an audio alarm or audio message will be provided by computer processor 10 to speaker 8 and a signal or signals may be sent to the police vehicle 200. Similarly, as soon as flapper or valve 22 is activated or closed the red indicator or LED 28 may be activated or lit up to indicate that the flapper or valve 22 is active (closed) and the green indicator or LED 26 may be shut off, or gradually dimmed until it is off.

When a police officer/s arrives at the scene of the stopped vehicle 1, wherein the flapper or valve 22 causes the vehicle 1 to stop, the police officer can re-open or deactivate the flapper or valve 22 by providing a signal from the computer processor 206 of the police vehicle 200 through a transmitter of the transmitter/receiver 202 to a receiver of the transmitter/receiver 16 of the vehicle 1. The signal is received by the computer processor 10 from a receiver of the transmitter/receiver 16, and the computer processor 10 causes the flapper or valve 22 to open, to allow gas flow from the tank 20 to the engine 24, in response to the police vehicle signal. The computer processor 206 and/or the computer memory 208 may include a master's driver's license or related computer software which allows the computer processor 206 to open the flapper or valve 22 or a flapper or valve 22 of any motor vehicle.

To reactivate a suspect's driver's digital license which may be part of computer memory 6 and/or the computer processor 10, that was deactivated the police patrol officer, in at least one embodiment, has to clamp a police officer's master driver's license, which may be in the form of a digital card, like a credit card, with the suspect's deactivated driver's license, which may be in the form a digital credit card, and the suspect's driver's license may be automatically reactivated. The computer processor 10 and/or the computer memory 6 may include a removable credit card size section and the computer processor 206 and/or the computer memory 208 may include a removable credit card size section for this purpose.

In at least one embodiment, to deactivate an alarm being emitted by speaker 8 due to activation of the flapper or valve 22, a police officer has to press a master driver's license credit card sized card over a section of the computer processor 10.

Generally, only one of the green indicator 26, the red indicator 28, and the yellow indicator 30 will be active and/or lit up at a time. However, in at least one embodiment, whenever flapper or valve 22 is activated and the vehicle gas line or gas flow from the tank 20 to the vehicle's engine 24 is blocked/interrupted the red indicator or LED light 28 of the vehicle 1 is activated to be blinking bright red light.

The technology, of one or more embodiments of the present invention, is applicable to pre-existing vehicles and motorcycles. The street stop sign(s), such as sign 100, and other traffic safety scanner/reader or device 2, in at least one embodiment, is water proof whether in an automobile or in a motorcycle. The sensing, reading, or viewing range of the street stop/s reader/scanner 2 may be about half a block to one block maximum. The location of scanner/reader 2 in the pre-existing vehicle may be on the left hand side of the vehicle dash board 4 and the scanner 2 preferably should not block a view of the driver of the motor vehicle 1. This scanner or device 2, in at least one embodiment, is preferably glued to the vehicle's dashboard 4 and may be engraved with the vehicle's VIN (vehicle identification number). The front of the scanner or device 2 faces a road/street/highway so that the device 2 can scan/read any of the traffic stop/s signs and safety traffic signs on our roads and highways. See FIG. 2. Also, the device 2 may be, or may include a micro camera facing outwards from the motor vehicle 1, typically towards a street/roads or highway that is being driven on. This micro camera or device 2 facing the road/street can see pedestrians crossing the street and alert the vehicle operator by causing the computer processor 10 to cause an audio message to be emitted via speaker 8 to say something like this “please watch for pedestrians crossing the street”.

The back of the device 2 may include a second micro camera 5. This second micro camera 5 facing backwards towards the driver, and receiving signals or images from the driver as shown by bidirectional line 5a in FIG. 1, is designed to monitor the tendencies of the driver of the vehicle 1, such as the tendencies to possibly drink and drive. Drinking and driving is a major problem facing our nation today and contributes immensely to the about forty thousand annual fatalities on our roads and highways. In at least one embodiment, this micro camera 5 at the back of the scanner 2 is linked or connected to every street police patrol vehicle in the state, such as through the computer processor 10 providing video data through a transmitter of the transmitter/receiver 16, to a receiver of the transmitter/receiver 202 and to the computer processor 206 of police vehicle 200, and to similar or identical components 202, 206 or similar or identical police vehicles.

In at least one embodiment, at any time (day/night time) if the micro camera 5 observes/witnesses the vehicle operator drinking and driving, the computer processor 10 compares image data to data stored in the computer memory 6 indicative of intoxication, and if the driver is determined to be intoxicated while driving, the computer processor 10 sends out an intoxicated driver signal or signals through a transmitter of transmitter/receiver 16 to nearby police vehicles, such as police vehicle 200. The intoxicated driver signal or signals may include the exact location of the intoxicated driver, with personal identification of the driver, and with the vehicle's license plate, make, model, color, and other characteristics of the vehicle so that the driver can be arrested before something bad happens.

In addition, in at least one embodiment, when the computer processor 10 detects tampering with the device 2, through for example video images from the anti-tampering camera 14, which may be compared with data in the computer memory 6, an audio alarm signal may be provided through speaker 8. At least two different audio alarms may be provided. For example one audio alarm may have a different pitch and tone from a second audio alarm. A first audio alarm via audio message emitted through speaker 8 may be activated by computer processor 10 when an intruder attempts to tamper with the device 2. A second audio alarm may be activated and corresponding audio message emitted from speaker 8 after multiple pre recorded warnings to the vehicle operator/driver and after he/she refuses to obey any applicable safety traffic rules and regulations, if the vehicle driver fails to listen to the prerecorded instruction to pull over to the curb.

If, after sufficient audio warnings, the driver does not pull his/her vehicle over to the curb, then the vehicle will come to a sudden stop in the middle of the road by activation of the flapper or valve 22 to cut off gas flow to the engine 24. With the vehicle 1 in the middle of the road, the computer processor 10 will cause an audio alarm to be emitted through speaker 8, to warn other drivers that there is an immobilized vehicle in the road. The audio alarm to warn other drivers may be substantially louder than the audio alarm to initially warn the driver of the motor vehicle 1.

Simultaneously, a nearby police patrol officer, such as in police vehicle 200 is alerted in his/her police patrol vehicle to the exact geographic location by for example GPS coordinates of the disabled/immobilized vehicle to come and (a) to reactivate suspect's temporarily suspended smart driver's license or a card or section of the computer processor 10 and (2) to open and/or deactivate the flapper or valve 22 to allow gas flow from the tank 20 to the engine 24, with a police master driver's license or card of the computer processor 206. The police master driver's license card may be exclusive to law enforcement agencies.

For pre-existing motorcycles, reader/scanner 2 may have the same features as the scanner/reader in the preexisting automobiles. However, the reader/scanner or device 2 may be situated next to a motorcycle odometer in between a motorcycle left and right handles. ?? show diagram ??

For newer vehicle/models the reader/scanner device 2 may be located on or in the vehicle front dashboard, such as dashboard 4, and/or the device 2 can be located next to a fan that cools down the vehicle's radiator when the vehicle gets hot. For brand new motorcycles the device 2 should preferably be in the same location as in pre existing motorcycles. The device 2 may also typically be waterproof in new model motorcycles with typically all the same features as in pre-existing motorcycles.

Each time the vehicle driver/operator turns on the motor vehicle 1 or turns on the ignition of the motor vehicle 1 by for example inserting and turning a key, or by having a key which does not require physical insertion, and pushing a button, the green indicator 26 is electronically activated and stays green until the red indicator 28 is activated due to a speeding or other traffic violation by the vehicle operator. The green indicator 26, which may be located on or near the vehicle odometer 12, indicates to the vehicle operator/driver that the flapper or valve 22 is open allowing gas to flow from the gas tank 20 to the engine 24 through flapper or valve 22.

However, in at least one embodiment, if the red indicator 28 begins blinking/flashing that indicates that the flapper or valve 22 has been closed, preventing flow of gas from the tank 20 to the engine 24.

Some of the major traffic violations that can lead to the automatic activation and closure of the vehicle flapper or valve 22 to close the vehicle's gas line to the vehicle's engine 24 and subsequent temporary deactivation of the operator driver's digital license include: (a) running a red light anytime of the day; (b) failure to stop for school bus dropping off or picking up students with the school bus sign fully and well displayed for motorist(s) to see; (c) driving under the influence (DUI) (d) driving into a one way street/do not enter/wrong way street/s; (e) failure to yield to student crossing the street (f) making a u turn in areas designated as no u-turn and (g) excessive speeding. Data for these violations may be stored in computer memory 6, and/or downloaded from the internet, such as through a receiver of the transmitter/receiver 16. Data from the scanner/reader 2 may be compared with data stored in the computer memory 6, and/or data from the internet to determine that a violation has occurred and what violation has occurred.

Excessive speeding may mean driving at more than ten miles per hour above the speed limit in an area where the posted speed limit is for instance at twenty-five miles per hour and a suspect's vehicle is driving at thirty-five miles per hour or when a suspect drives his/her vehicle more than sixty five miles per hour where the posted speed limit in that area is fifty-five miles per hour. The first and/or second time a driver of vehicle 1 violates any of the applicable traffic rules and regulations, he/she may get a warning and pay some fines to a particular city/municipality. If the same suspect violates any of the applicable traffic rules and regulations the third time the suspects insurance company may be alerted electronically such as through a signal being sent by a transmitter of transmitter/receiver 16, such as through an email to an email address of an insurance company.

In at least one embodiment, anytime the vehicle operator/driver attempts to start the motor vehicle 1, such as by putting a vehicle's ignition key into a key slot and turning, or by pushing a button when a wireless key is present, the computer processor may be programmed to cause an audio message to be played by the speaker 8, wherein the audio message states: “This vehicle is equipped with a smart driver's license technology. You need a smart driver's license to operate this vehicle or the vehicle's ignition system will be disabled and this vehicle will be rendered inoperable. In addition, this vehicle is equipped with traffic safety apparatus technology. All speed limits and all safety traffic rules and regulations must be followed to avoid possible abrupt interruptions of your journey”.

As the vehicle operator drives he/she may many of the stop signs, safety traffic signs and rules such as speed limit which may thirty-five miles per hour. In at least one embodiment, at about half a block before the speed limit sign of thirty-five miles per hour, the scanner/reader 2 reads the posted speed limit and provides data concerning that to the computer processor 10. The computer processor 10 upon receiving signals indicating a posted speed limit has been sensed by device 2 and determining the nature of the speed limit signals, the computer processor 10 cause the speaker 8 to provide an audio message, such as “the speed limit in this area is thirty-five miles per hour.”

In at least one embodiment, when the scanner/reader 2 approaches and is within a specified distance of traffic sign or traffic regulation, the computer processor 10 receives signals from the device 2, determines the nature of the sign or regulation and announces same to the vehicle operator via the speaker 8. There may also be an additional message such as “please watch your speed and obey the posted speed limit.

Whenever a suspect's vehicle gas line to the vehicle's engine 24 is interrupted electronically by closing flapper or valve 22 for the violation of any of the traffic rules and traffic regulations, the suspect's smart driver's license (which may be a component which is part of the computer processor 10, but can be separated from the rest of computer processor 10 and carried similar to a credit card) may be simultaneously temporarily deactivated. At the same time any nearby police patrol officer vehicle, such as police vehicle 200 may be alerted in his/her police patrol vehicle to the exact geographic location where the vehicle 1 has been immobilized.

Prior to the activation or closure of flapper or valve 22, the suspect/driver will typically hear three prerecorded audio messages, retrieved from the computer memory 6, emitted through the speaker 8, for the driver to pullover to the corner of the road such as these: “(a) warning one: “please pull over” (b) warning two: “please pull over” and (c) warning three: “please pullover”. In at least one embodiment, after the three warnings, whether the driver pulls over or not, the flapper or valve 22 is activated or closed, and the suspect's vehicle will come to an automatic stop.

Another prerecorded warning, stored in the computer memory 6, may state “sorry I have to act” through the speaker 8. At that point any nearby police patrol officer/s will be electronically alerted in the police patrol vehicle, such as vehicle 200, to come to the scene to reinstate this suspect's digital driver's license and to deactivate the flapper or valve 22.

In at least one embodiment, the computer processor 206 and/or the computer memory 208 may include a card or section, which can be separated from the rest of 206 or 208 and which may be called a law enforcement exclusive master driver's license. The exclusive master driver's license may provide a signal to a receiver of the transmitter/receiver 16 to automatically/immediately deactivate or open the flapper or valve 22, and this will cause the computer processor 10 to stop the blinking of the red light indicator 28 and to turn the green indicator 26 on or light it up.

A ticket may be issued by a police officer using police vehicle 200. The ticket may be issued depending on a suspect's number of violations. With the opening of the flapper or valve 22 to allow gas flow to the engine 24, and the activation of the suspect's digital driver's license, a suspect's vehicle will be operational again and he/she will be on his/her way. The suspects may be given a warning or ticket. The suspect's auto insurance company shall be alerted electronically depending on the number of warnings to date to the suspect. After three warnings the suspect's auto insurance company should be alerted electronically. In at least one embodiment, for a family of three or more that have only one vehicle every offense may be recorded under their driver's license column in a database in their auto insurance company.

In at least one embodiment, If the reader/scanner senses that the vehicle 1 is approaching a traffic light when the light is showing red, the computer processor 10 will cause an audio message to be emitted from the speaker 8 which states “stop for the red light”. When the traffic light is yellow the driver will be advised by an audio message emitted through the speaker 8 to “be prepared to stop”. As the vehicle operator/driver approaches any of the traffic signs and safety regulations the vehicle's scanner/reader 2 will scan/read any of the signals and announce to the vehicle operator the proper action to take.

The master driver's license of the computer processor 6 may be universal, and uniform, in the sense that all police vehicles may have the same master's driver's license. The master's driver's license may include or consist of computer software stored in computer memory 208 and implemented by the computer processor 206.

In one embodiment of the present invention, if a vehicle operator from New Jersey drives to New York and violates any of the traffic rules and regulations in New York, the New Jersey smart driver's license for the operator will automatically be temporarily deactivated by the computer processor 10, such as by setting a flag in the computer memory 6, an alarm device may be activated through speaker 8; the vehicle's flapper or valve 22 may be activated (closed) to prevent gas flow to the engine 24 and the New Jersey registered vehicle may be be demobilized. Subsequently, any nearby New York police patrol officer, such as in police vehicle 200 may be alerted through a signal received by a receiver of the transmitter/receiver 202 to the geographic location where the New Jersey registered vehicle is demobilized. The New York police patrol officer can both use his/her master driver's license of the computer processor 206 and/or the computer memory 208 to reactivate the temporarily deactivated New Jersey smart driver's license, and to close the suspect's flapper or valve 22 to allow gas flow to the engine 24 from tank 20.

In addition, in at least one embodiment, whenever any vehicle operator of vehicle 1 attempts to violate any of the applicable traffic rules and regulations a prerecorded warning to the driver says something to the vehicle operator “don't do it because of the consequences and you may lose your driver's license”. In at least one embodiment, any violation of the applicable traffic rules and regulations automatically triggers the activation (closure) of flapper or valve 22, deactivates the vehicles operator's smart driver's license and provides a subsequent alert to any nearby police patrol officer in his/her police vehicle to come to the geographic location where the vehicle 1 is to issue a ticket to this driver/suspect.

Whenever the flapper or valve 22 is activated (to block gasoline supply) to the vehicle's engine 24 due to violations of any of the traffic signs or regulations, typically as stored in the computer memory 6, in at least one embodiment, a prerecorded warning that says something like this to the vehicle operators: “please do not panic. A nearby police patrol officer/s have been alerted and is on his/her way to the scene” to help you get back on the road.

In at least one embodiment, whenever any cellphone is not being used for making phone calls and/or texting, the cell phone automatically transitions or kicks into camera mode and is able to capture the facial appearances of any intruders to the phone owner's space and relays the same to a home monitoring center.

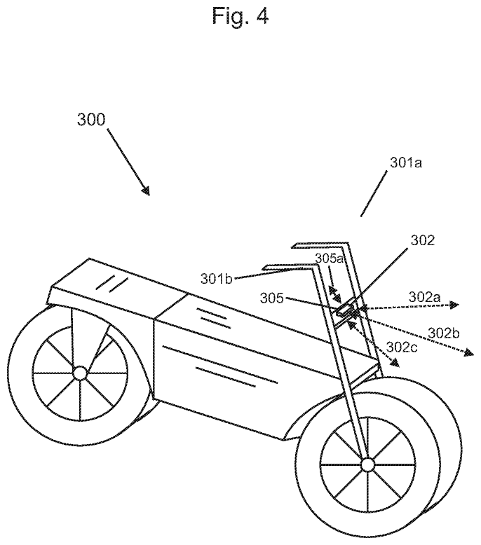

As shown in FIG. 4, a camera 305 may be located between the handle bars 301a and 301b of a motorcycle 300 and may face back towards a motorcycle driver, similar or identical to the micro camera 5 of FIG. 1. The camera 305 may receive signals or images from the driver of the motorcycle 300 as shown by bidirectional line 305a in FIG. 4, and may be designed to monitor the tendencies of the driver of the motorcycle 300, such as the tendencies to possibly drink and drive. In at least one embodiment, this micro camera 305 may be at the back of a scanner 302 and the camera 305 may be linked or connected to every street police patrol vehicle in the state, such as through a computer processor similar or identical to the computer processor 10 providing video data through a transmitter of a transmitter/receiver identical or similar to transmitter/receiver 16, to a receiver of the transmitter/receiver 202 and to the computer processor 206 of police vehicle 200, and to similar or identical components 202, 206 or similar or identical police vehicles. The scanner 302 may emit signals or received signals as shown by the bidirectional dashed lines 302a, 302b, and 302c in FIG. 4.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a computer processor;
a computer memory, which communicates with the computer processor; and
a sensor for detecting traffic signs, which communicates with the computer processor;
wherein the computer memory includes data regarding a plurality of safety regulations for vehicles;
wherein the computer processor receives signals from the sensor, and determines whether a vehicle is violating one or more the safety regulations for vehicles based on the signals from the sensor and the data for the plurality of safety regulations stored in the computer memory, and provides a warning signal when a safety regulation is violated.

2. The apparatus of claim 1 further comprising
a speedometer which communicates with the computer processor;
wherein the computer processor is programmed by computer software stored in computer memory to receive speeds from the speedometer to determine if one or more of the safety regulations for vehicles have been violated.

3. The apparatus of claim 1 further comprising
a flapper which is controlled by the computer processor to prevent gas from a gas tank from flowing into an engine of a vehicle when the computer processor detects that one or more of the safety regulations for vehicles have been violated.

4. The apparatus of claim 2 further comprising
a yellow indicator light which communicates with the computer processor and which is turned on when a speed of a vehicle as determined by the speedometer is above a first threshold but below a second threshold.

5. The apparatus of claim 4 further comprising
a red indicator light which communicates with the computer processor and which is turned on when a speed of a vehicle as determined by the speedometer is above the second threshold.

6. The apparatus of claim 1 further comprising
a camera which is configured to take images of a driver of a vehicle and which communicates with the computer processor; and
wherein the computer processor is programmed by computer software stored in the computer memory to provide a warning signal when the images of the driver indicate that the driver is not following one or more of the safety regulations.

7. A method comprising
fixing an apparatus to a motor vehicle; wherein the apparatus includes:
a computer processor;
a computer memory, which communicates with the computer processor; and
a sensor for detecting traffic signs, which communicates with the computer processor;
wherein the computer memory includes data regarding a plurality of safety regulations for vehicles;
wherein the computer processor receives signals from the sensor, and determines whether a vehicle is violating one or more the safety regulations for vehicles based on the signals from the sensor and the data for the plurality of safety regulations stored in the computer memory, and provides a warning signal when a safety regulation is violated.

8. The method of claim 7 wherein the apparatus includes:
a speedometer which communicates with the computer processor;
wherein the computer processor is programmed by computer software stored in computer memory to receive speeds from the speedometer to determine if one or more of the safety regulations for vehicles have been violated.

9. The method of claim 7 wherein the apparatus includes:
a flapper which is controlled by the computer processor to prevent gas from a gas tank from flowing into an engine of a vehicle when the computer processor detects that one or more of the safety regulations for vehicles have been violated.

10. The method of claim 9 wherein the apparatus includes:
a yellow indicator light which communicates with the computer processor and which is turned on when a speed of a vehicle as determined by the speedometer is above a first threshold but below a second threshold.

11. The method of claim 10 wherein the apparatus includes:
a red indicator light which communicates with the computer processor and which is turned on when a speed of a vehicle as determined by the speedometer is above the second threshold.

12. The method of claim 7 wherein the apparatus includes:
a camera which is configured to take images of a driver of a vehicle and which communicates with the computer processor; and
wherein the computer processor is programmed by computer software stored in the computer memory to provide a warning signal when the images of the driver indicate that the driver is not following one or more of the safety regulations.
